(19) United States
(12) Patent Application Publication
(10) Pub. No.: US 2024/0061182 A1
(43) Pub. Date: Feb. 22, 2024

(54) PACKAGING LANYARD FOR CONNECTOR CONVERTERS

(71) Applicant: CommScope Technologies LLC, Claremont, NC (US)

(72) Inventors: Yu LU, Eden Prairie, MN (US); Ryan M. Kostecka, Waconia, MN (US)

(21) Appl. No.: 18/385,059

(22) Filed: Oct. 30, 2023

Related U.S. Application Data
(63) Continuation of application No. PCT/US2022/027109, filed on Apr. 29, 2022.
(60) Provisional application No. 63/186,058, filed on May 7, 2021.

(51) Int. Cl. G02B 6/36

(52) U.S. Cl. CPC G02B 6/3616

(57) ABSTRACT

A retention and protection device holds one or more envelope attachments to a connector core. The envelope attachment may be removed from the device and installed upon the connector core to convert the connector core into a different type of connector to mate with or within a different style of connector or port. The device is a combination of features including a clasp for attachment to the connector core, such as by residing within a recessed valley of a strain relief boot of the connector core. One or more lanyards may be provided. Each lanyard has a first end attached to the clasp and a second end with a fitting. The fitting is structurally dimensioned to removably hold an envelope attachment and prevent dust from entering one end of the envelope attachment. Once removed from the fitting, the envelope attachment is structurally compatible to attach to the connector core.

This application is a continuation of International Application No. PCT/US2022/027109, filed Apr. 29, 2022, which claims the benefit of U.S. Provisional Application Ser. No. 63/186,058, filed May 7, 2021, both of which are herein incorporated by reference.

### BACKGROUND OF THE INVENTION

### 1. Field of the Invention

The present invention relates to a connector for presenting one or more communication carrying mediums for transmitting and/or receiving communication signals. More particularly, the present invention relates to a device which attaches to a connector core of the connector and holds and protects one or more envelope attachments, which may be removed from the device and secured to the connector core to change the connector core into various formats of connectors.

### 2. Description of the Background

FIGS. 1 and 2 are labeled “Background Art,” as the structures therein are not prior art to the present invention. The structures were previously invented by the same inventive entity and are the subject of earlier filed patent applications. See the disclosure of PCT Publication WO 2021/041305 A1, published Mar. 4, 2021, and also the disclosures found in U.S. Provisional applications 62/891,842 and 63/003,988, filed Aug. 26, 2019 and Apr. 2, 2020, respectively.

In FIG. 1 is a perspective view of a connector core 23, which terminates a fiber optic cable 22. One or more optical fibers within the fiber optic cable may be fixed within a ferrule 66, e.g., by epoxy. Ends of the one or more optical fibers may be polished and presented at the end of the ferrule 66 for transmitting and/or receiving communication signals. Although the connector core 23 is shown as being a core of an optical connector, other types of connectors may be employed, such as electrical and hybrid connectors, as long as the connector core 23 presents one or more communication carrying mediums for transmitting and/or receiving communication signals.

A strain relief boot 28 provides strain relief between the connection of the fiber optic cable 22 and the connector core 23. A turn-to-secure fastener 26 is mounted around the connector core 23. The turn-to-secure fastener 26 may rotate at least partially about the center axis A of the connector core 23. The turn-to-secure fastener 26 may rotate in unison with, or independent of, the strain relief boot 28.

An interior coupling arrangement 27 is provided inside of the turn-to-secure fastener 26. When the connector core 23 is not in use, a dust cap 32 is secured over the connector core 23. The dust cap 32 has an exterior coupling arrangement 83, which includes features to engage with the interior coupling arrangement 27 within the turn-to-secure fastener 26, such as axial retention stops 106. After, the exterior coupling arrangement 83 is inserted into the turn-to-secure fastener 26, the turn-to-secure fastener 26 is rotated, e.g., about forty-five degrees, so that the axial retention stops 106 are captured by the interior coupling arrangement 27 within the turn-to-secure fastener 26 in a bayonet locking style. When the dust cap 32 is removed, the connector core 23 can be mated to a compatible second connector or within a compatible port.

As best illustrated in FIG. 2, the outer structural features of the connector core 23 can also be modified by first or second envelope attachments 34 and 36, such as the first and second hardened connector shroud and fastener arrangements, discussed in PCT Publication WO 2021/041305 A1. The first and second envelope attachments 34 and 36 have an open rear end R which may be inserted over the connector core 23 when the dust cap 32 is removed from the connector core 23. The rear end R of the first and second envelope attachments 34 and 36 include the same exterior coupling arrangement 83 with axial retention stops 106, so that the turn-to-secure fastener 26 may secure one of the first or second envelope attachments 34 and 36 onto the connector core 23.

The first and second envelope attachments 34 and 36 may each include a dust cap 244 secured thereto by a lanyard 242. When the dust cap 244 is removed, the exposed structural features of the first and second envelope attachments 34 and 36 will have converted the connector core 23 into a different style of connector, such as a FastConnect™ fiber optic adaptor, as sold by Huawei Technologies Company Ltd. or an Opti Tap™ fiber optic adapter, as sold by Corning Cable Systems, LLC.

A greater understanding of the features of the connector core 23 and how the connector core 23 can be mated to different envelope attachments 34 and 36 to form different types of fiber optic connectors can be found in the Applicant's prior patent applications and publications, by the same inventive entity. As such, this application incorporates by reference the disclosure of PCT Publication WO 2021/041305 A1, published Mar. 4, 2021, and also incorporates by reference the disclosures found in U.S. Provisional applications 62/891,842 and 63/003,988, filed Aug. 26, 2019 and Apr. 2, 2020, respectively.

### SUMMARY OF THE INVENTION

PCT Publication WO 2021/041305 A1, as published Mar. 4, 2021, described the CommScope Prodigy™ connector system. The system includes one or more envelope attachments, which may be attached to the connector core. One potential downside was that the various envelope attachments were separately provided and were not attached to the connector core. As such, the loose envelope attachments could be placed into a tool bag of the technician, where they could be lost or damaged. Further, the open rear ends of the envelope attachments may accumulate dust and debris from the other items in the tool bag of the technician, e.g., rag threads and paper dust.

It is an object of the present invention to provide a retention and protection device, which holds one or more envelope attachments to a connector core. The envelope attachment may be removed from the device and installed upon the connector core to convert the connector core into a different type of connector to mate with or within a different style of connector or port. The device is a combination of features including a clasp for attachment to the connector core, such as by residing within a recessed valley of a strain relief boot of the connector core. One or more lanyards may be provided. Each lanyard has a first end attached to the clasp and a second end with a fitting. The fitting is structurally dimensioned to removably hold an envelope attachment and prevent dust from entering the rear end of the envelope attachment. Once removed from the fitting, the envelope attachment is structurally compatible to attach to the connector core.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

For a better understanding of the invention, and to show how the same may be carried into effect, reference will now be made, by way of example, to the accompanying drawings, in which:

FIG. 1 is a front perspective view of a fiber optic cable terminated to a connector core with a dust cap removed therefrom, in accordance with the background art;

FIG. 2 illustrates first and second envelope attachments which may optionally be secured to the connector core of FIG. 1, in accordance with the background art;

FIG. 3 is a perspective view of a device to couple two uninstalled envelope attachments to a connector core, while also providing dust protection to the rear ends of the envelope attachments;

FIG. 4 is a bottom view of the device of FIG. 3;

FIG. 5 is a cross-sectional view taken along line V-V in FIG. 4;

FIG. 6 is a closeup view of section B in FIG. 5;

FIG. 7 is a perspective view the device of FIG. 3 attached to the connector core and holding first and second envelope attachments;

FIG. 8 is a cross-sectional view taken along line VIII-VIII in FIG. 7;

FIG. 9 is a perspective view similar to FIG. 7, but showing a first envelope attachment removed from a first fitting of the device;

FIG. 10 is a perspective view similar to FIG. 9, but showing the first envelope attachment mounted to the connector core;

FIG. 11 is a perspective view of a first alternative device to couple three uninstalled envelope attachments to a connector core;

FIG. 12 is a perspective view of a second alternative device to couple one uninstalled envelope attachment to a connector core;

FIG. 13 is a perspective view the second alternative device of FIG. 12 attached to the connector core and holding an envelope attachment;

FIG. 14 is a perspective view similar to FIG. 12, but showing an alternative clasp design;

FIG. 15 is a cross-sectional view taken along line C-C in FIG. 12, but showing a first alternative fitting design;

FIG. 16 is a cross-sectional view taken along line C-C in FIG. 12, but showing a second alternative fitting design;

FIG. 17 is a cross-sectional view taken along line C-C in FIG. 12, but showing a third alternative fitting design;

FIG. 18 is a perspective view of the third alternative fitting design in FIG. 17; and

FIG. 19 is a view of the inner surface of a sleeve of the fitting of FIGS. 17 and 18, if unrolled and opened in a flat state.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

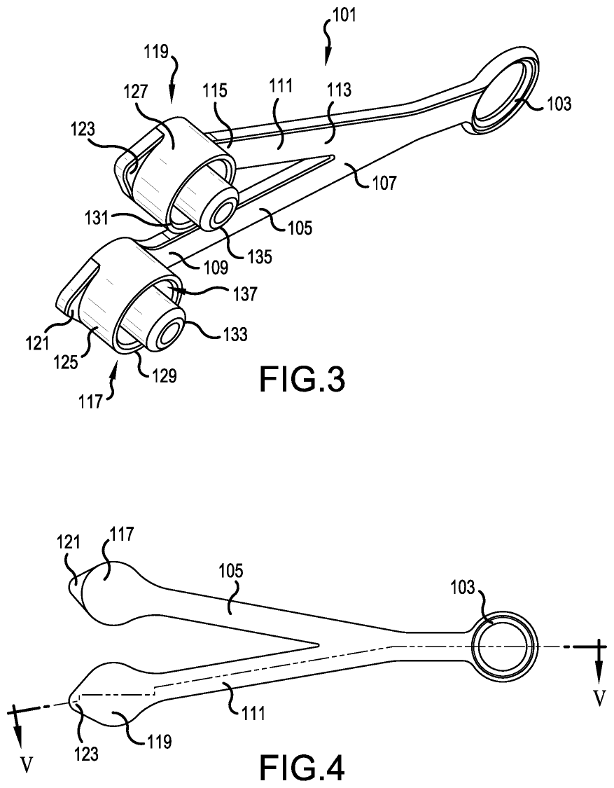

FIG. 3 is a perspective view of a device 101 to couple two uninstalled envelope attachments to a connector core 23, while also providing dust protection to the rear ends of the envelope attachments. The device 101 includes a combination of structural features, such as a clasp 103 for attachment to the connector core 23, e.g., the strain relief boot 28 of the connector core 23. A first lanyard 105 has a first end 107 and an opposite, second end 109. The first end 107 of the first lanyard 105 is attached to the clasp 103. A second lanyard 111 has a first end 113 and an opposite, second end 115. The first end 113 of the second lanyard 111 is also attached to the clasp 103. The phrase “attached to” includes configurations such as welding, adhesive, fasteners and/or being integrally formed therewith, such as integrally molded, and may also include one or more intervening parts.

A first fitting 117 is attached to the second end 109 of the first lanyard 105. A second fitting 119 is attached to the second end 115 of the second lanyard 111. The second fitting 119 and the first fitting 117 are structurally dimensioned to removably hold envelope attachments for the connector core 23. In a preferred embodiment, the first and second fittings 117 and 119 are identically formed.

In one embodiment, at least the first and second lanyards 105 and 111 are formed of a flexible plastic, and in a preferred embodiment, the entirely of the device 101 may be formed of a flexible and resilient plastic material. First and second finger tabs 121 and 123 may be provided for the first fitting and said second fittings 117 and 119, respectively. The first and second finger tabs 121 and 123 project away from first and second outer surfaces 125 and 127 of first and second outer sleeves 129 and 131 of the first and second fittings 117 and 119. The first and second finger tabs 121 and 123 assist with removing the first and second fittings 117 and 119 from the envelope attachments.

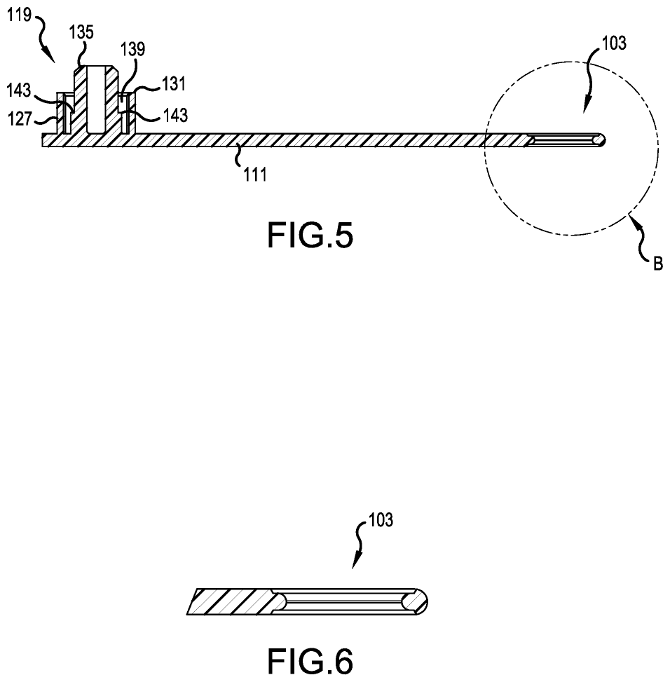

FIG. 4 is a bottom view of the device 101 of FIG. 3. FIG. 5 is a cross-sectional view taken along line V-V in FIG. 4, and FIG. 6 is a closeup view of section B in FIG. 5. FIGS. 4-6 show example dimensions in millimeters for the various features of the device 101.

As best seen in FIG. 5, the second fitting 119 includes the second outer sleeve 131, with an inner diameter of less than 10 mm. A second inner plug 135 is center inside of the second outer sleeve 131, so that a second gap 139 is formed between the second outer sleeve 131 and the second inner plug 135. In a preferred embodiment, the second outer sleeve 131 and the second inner plug 135 are formed of a resilient, plastic material, so that the second outer sleeve 131 or the second inner plug 135 or both are deformed when a circular portion 140 of a first or second envelope attachment 34 or 36 is inserted into the second gap 139, as best seen in FIG. 8. In a preferred embodiment, at least one of an inner surface of the second outer sleeve 131 and an outer surface of the second inner plug 135 includes a second bulbous portion 143, which narrows the second gap 139.

The first fitting 117 may be formed identically to the second fitting 119. Therefore, the first fitting 117 may include the first outer sleeve 129, with an inner diameter of less than 10 mm. A first inner plug 133 is center inside of the first outer sleeve 129, so that a first gap 137 is formed between the first outer sleeve 129 and the first inner plug 133. The first outer sleeve 129 and the first inner plug 133 may be formed of a resilient, plastic material, so that the first outer sleeve 129 or the first inner plug 133 or both are deformed when a circular portion 140 of the first or second envelope attachment 34 or 36 is inserted into the first gap 137, as best seen in FIG. 8. In a preferred embodiment, at least one of an inner surface of the first outer sleeve 129 and an outer surface of the first inner plug 133 includes a first bulbous portion 141, which narrows the first gap 137.

As best seen in FIGS. 4 and 6, the clasp 103 is formed as an eyelet. In a preferred embodiment, the plastic material used to form the clasp 103 has enough flexibility and resilience to allow the eyelet to be manually expanded in diameter to pass over the turn-to-secure fastener 26 and then snap back to its original diameter to seat into, and be secured within, one of the recessed valleys of the strain relief boot 28 of the connector core 23.

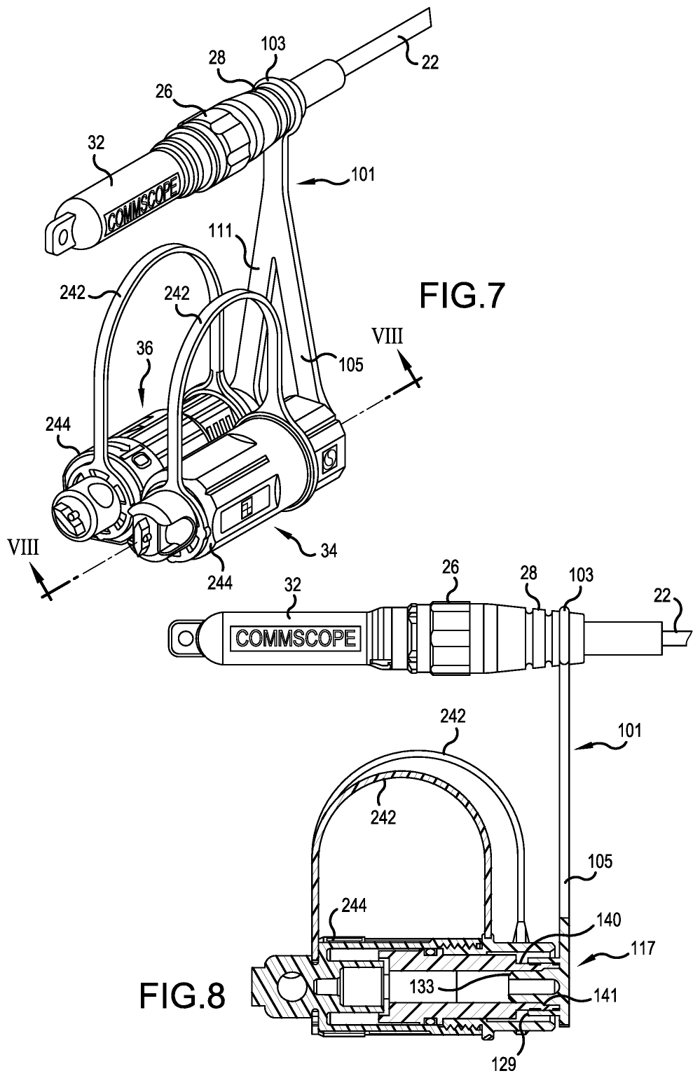

FIG. 7 is a perspective view the device 101 of FIG. 3 attached to the connector core 23 and holding the first and second envelope attachments 34 and 36. FIG. 8 is a cross-sectional view taken along line VIII-VIII in FIG. 7. As best seen in FIG. 8, the circular portion 140 of the first envelope attachment 34 is inserted into the first gap 137. The resilient, plastic material used to form the first outer sleeve 129 and the first inner plug 133 can deform to create a friction fit so that the first envelope attachment 34 is retained by the first fitting 117. If the first bulbous portion 141 is provided, the friction may be increased as the circular portion 140 is pressed further into the first fitting 117

FIG. 9 is a perspective view similar to FIG. 7, but showing the first envelope attachment 34 removed from the first fitting 117 of the device 101. To remove the first envelope attachment 34, a technician pinches the finger tab 121 and pulls the first envelope attachment 34 free from its frictional engagement within the first fitting 117. Once free, the dust cap 32 is removed from the connector core 23 by providing a forty-five degree counter-clockwise twist to the turn-to-secure fastener 26 while holding the dust cap 32 and then sliding the dust cap 32 off of the connector core 23.

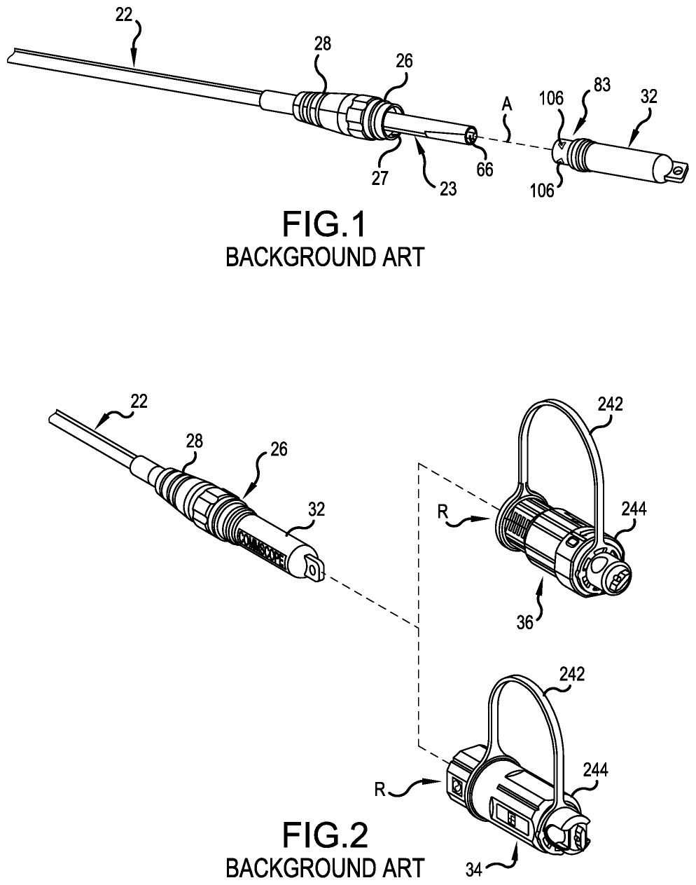

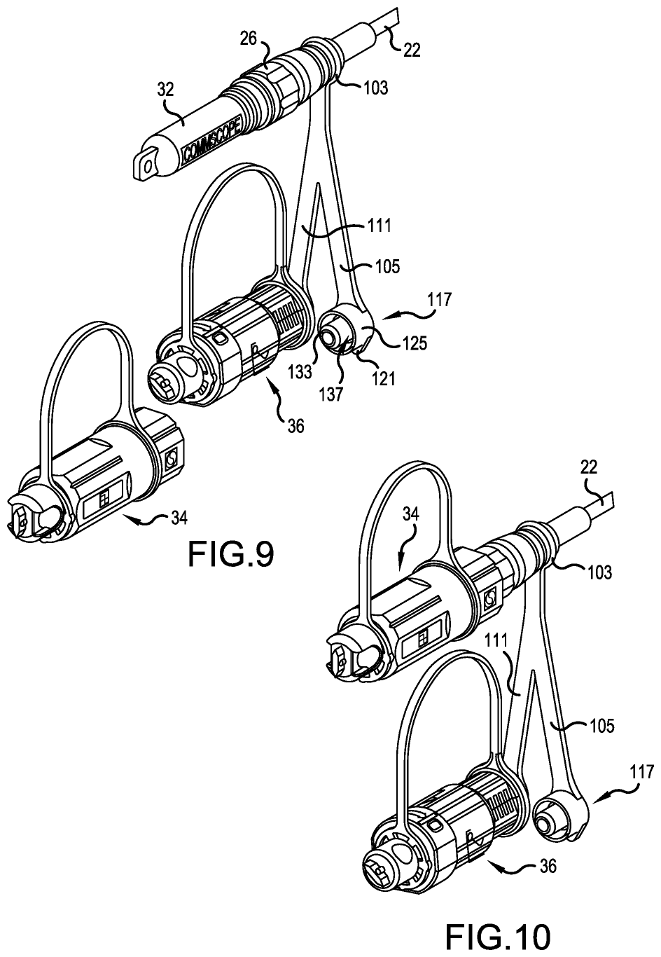

FIG. 10 is a perspective view similar to FIG. 9, but illustrates the first envelope attachment 34 mounted to the connector core 23. The circular portion 140 within the open rear end R will be configured the same as the exterior coupling arrangement 83 of the dust cap 32 (See FIG. 1). In a sense, the first fitting 117 which can hold the first envelope attachment 34 is structurally similar to the mating interface of the twist-to-secure fastener 26, meaning that the first fitting 117 is not structurally compatible to attach to the connector core 23.

When the circular portion 140 of the first envelope attachment 34 is inserted into the turn-to-secure fastener 26, the turn-to-secure fastener 26 is rotated, e.g., about forty-five degrees in the clockwise direction, so that the axial retention stops 106 are captured by the interior coupling arrangement 27 within the turn-to-secure fastener 26 in a bayonet locking style. Optionally, an interlock may be employed so that the first envelope attachment 34 may not be removed from the twist-to-turn fastener 26 unless the first envelope attachment 34 is broken open and the interlock is disengaged.

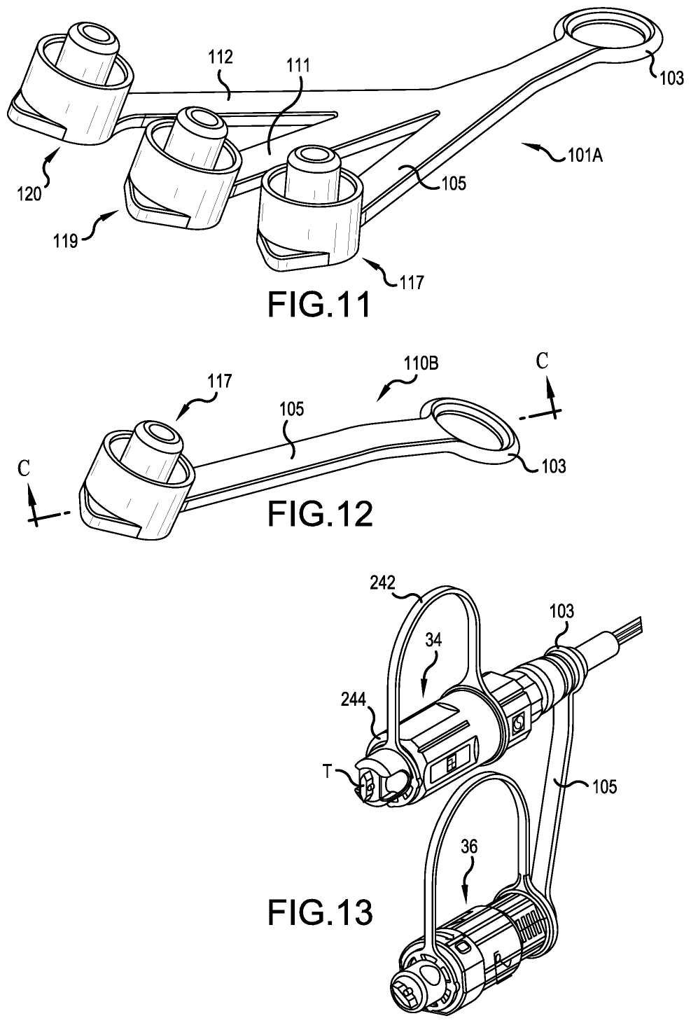

FIG. 11 is a perspective view of a first alternative device 101A to couple three uninstalled envelope attachments to the connector core 23. It is envisioned that the system of the present invention may provide two or more, e.g., three, four or more, different envelope attachments to convert the connector core 23 into a wide range of connector types, such as a first class of connector, a second class of connector and a third class of connector, wherein the first, second and third classes of connectors are each different from the others. As such the first alternative device 101A may include first, second and third fittings 117, 119 and 120 at second ends of first, second and third lanyards 105, 111 and 112, respectively.

FIG. 12 is a perspective view of a second alternative device 101B to couple one uninstalled envelope attachment to the connector core 23. From the factory, the first envelope attachment 34 may be pre-loaded onto the connector core and the second envelope attachment 36 may be frictionally engaged within the first fitting 117 of the second alternative device 101B, as depicted in FIG. 13. If the technician desires to use the first envelope attachment 34, no modification is needed. If the second envelope attachment 36 is desired, the first envelope attachment 34 may be removed from the connector core 23 using the tool T at the end of dust cap 244. Then, the first envelope attachment 34 may be replaced by the second envelope attachment 36. The first envelope attachment 34 may then be frictionally engaged within the first fitting 117 or recycled.

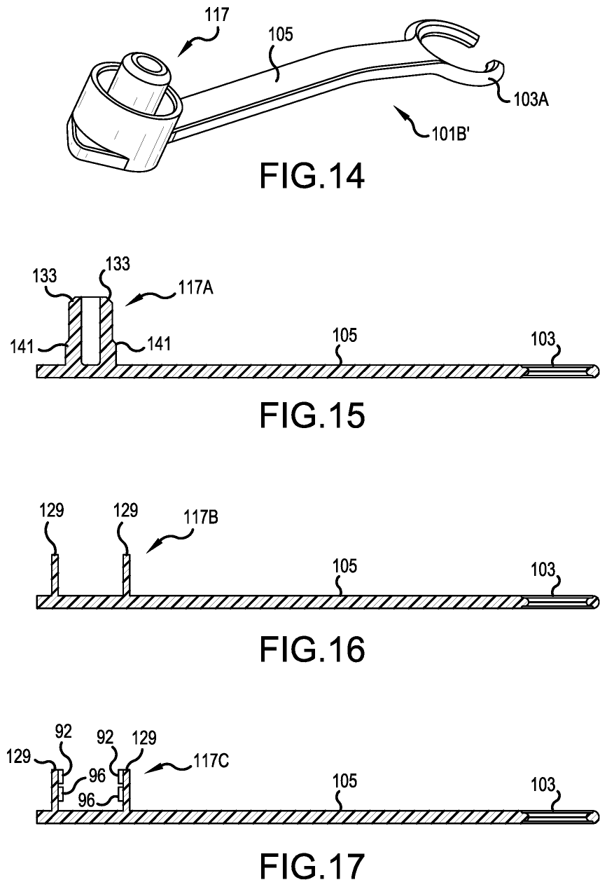

FIG. 14 is a perspective view similar to FIG. 12, but showing the second alternative device 101B′ with an alternative clasp 103A. The alternative clasp 103A is formed as a resilient open-sided ring, which may snap over the connector core 23, e.g., around the strain relief boot 28. The alternative clasp 103A may include a horseshoe-shaped, spring-metal clip, which is over molded with the plastic material used to form the remainder of the second alternative device 101B′. The shape of the alternative clasp 103A is designed so that less deformation is needed in order to mount the alternative clasp 103A onto the strain relief boot 28, and so that the second alternative device 101B′ may be more easily removed from the strain relief boot 28 if desired.

FIG. 15 is a cross-sectional view taken along line C-C in FIG. 12, but showing a first alternative fitting 117A. The first alternative fitting 117A has only the first inner plug 133, which under some circumstances may be sufficient to provide enough frictional force to retain an envelope attachment 34 or 36.

FIG. 16 is a cross-sectional view taken along line C-C in FIG. 12, but showing a second alternative fitting 117B. The second alternative fitting 117B has only the first outer sleeve 129, which under some circumstances may be sufficient to provide enough frictional force to retain an envelope attachment 34 or 36.

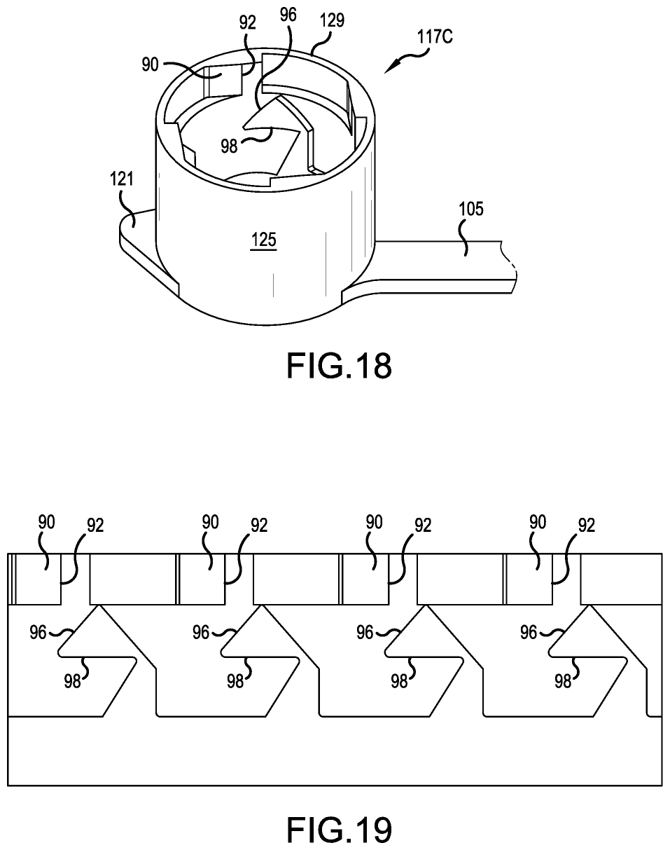

FIG. 17 is a cross-sectional view taken along line C-C in FIG. 12, but showing a third alternative fitting 117C. FIG. 18 is a perspective view of the third alternative fitting 117 in FIG. 17. With the third alternative fitting 117C, an inner surface of the first outer sleeve 129 includes a plurality of projections and pathways 90, 92, 96 and 98, which can interact with pathways and projections, e.g., the axial retention stops 106, formed on an outer surface of the circular portion 140 of the first or second envelope attachments 34 or 36. For example, insertion and partial rotation of the first envelope attachment 34 into the first outer sleeve 129 results in a bayonet-type retention, so that the third alternative first fitting 117C holds the first envelope attachment 34. The first inner plug 133 has been omitted in FIGS. 17 and 18, but may also be included. FIG. 19 is a view of the inner surface of the first sleeve 129 of the third alternative fitting 117C of FIGS. 17 and 18, if unrolled and opened in a flat state. FIG. 19 is the same as FIG. 22 in the previously incorporated disclosure of PCT Publication WO 2021/041305 A1. Additional information concerning an embodiment of a bayonet-style locking system may be obtained by reference to the PCT publication.

The present invention provides a reliable way to hold envelope attachments 34 and 36 to the connector core 23 until needed for an installation to the connector core 23. An envelope attachment is meant to broadly refer to an arrangement or adapter, such as the first hardened connector shroud and fastener arrangement 34, the second hardened connector shroud and fastener arrangement 36 or the small form-factor fiber optic adapter 38, mentioned in PCT Publication WO 2021/041305 A1. The envelope attachment 34 or 36 modifies one or more of the external structural features of the connector core 23, so that the connector core 23 may physically connect to or within different connectors or different ports, and so that the one or more communication carrying mediums carried by the connector core, such as one or more optical fibers, are brought into mating communication with one or more communication carrying mediums carried by the mated connector or mated port.

We claim:

1. A combination comprising:
a clasp for attachment to a connector core;
a first lanyard having a first end and an opposite, second end, wherein said first end of said first lanyard is attached to said clasp;
a second lanyard having a first end and an opposite, second end, wherein said first end of said second lanyard is attached said clasp;
a first fitting attached to said second end of said first lanyard; and
a second fitting attached to said second end of said second lanyard, wherein said second fitting and said first fitting are structurally dimensioned to removably hold envelope attachments for the connector core.

2. The combination according to claim 1, wherein said clasp is formed as an eyelet.

3. The combination according to claim 1, wherein said clasp is formed as a resilient open-sided ring, which may snap over the connector core.

4. The combination according to claim 1, wherein said first and second fittings are identically formed.

5. The combination according to claim 1, wherein said first and second lanyards are formed of a flexible plastic.

6. The combination according to claim 1, wherein each of said first fitting and said second fitting includes:
an outer sleeve;
an inner plug; and
a gap formed between said outer sleeve and said inner plug, wherein said outer sleeve and said inner plug are formed of a resilient, plastic material, and wherein said outer sleeve or said inner plug or both are deformed when a circular portion of the envelope attachment is inserted into said gap.

7. The combination according to claim 6, wherein at least one of an inner surface of said outer sleeve and an outer surface of said inner plug includes a bulbous portion, which narrows said gap.

8. The combination according to claim 6, wherein an inner diameter of said outer sleeve is less than 10 mm.

9. The combination according to claim 6, wherein each of said first fitting and said second fitting further includes and finger tab projecting away from an outer surface of said outer sleeve to assist with removing said first and second fittings from the envelope attachments.

10. The combination according to claim 1, further comprising:
a third lanyard having a first end and an opposite, second end, wherein said first end of said third lanyard is attached said clasp; and
a third fitting attached to said second end of said third lanyard, wherein said third fitting is structurally dimensioned to removably hold an envelope attachment for the connector core.

11. A combination comprising:
a connector core presenting one or more communication carrying mediums for transmitting and/or receiving communication signals;
a clasp attached to said connector core;
a first lanyard having a first end and an opposite, second end, wherein said first end of said first lanyard is attached to said clasp;
a first fitting attached to said second end of said first lanyard; and
a first envelope attachment removably attached to said first fitting, wherein said first envelope attachment has external features to physically attach said first envelope attachment to said connector core when said first envelope attachment is removed from said first fitting.

12. The combination according to claim 11, further comprising:
a second lanyard having a first end and an opposite, second end, wherein said first end of said second lanyard is attached to said clasp;
a second fitting attached to said second end of said second lanyard; and
a second envelope attachment removable attached to said second fitting, wherein said second envelope attachment has external features to physically attach said second envelope attachment to said connector core when said second envelope attachment is removed from said second fitting.

13. The combination according to claim 12, wherein said first envelope attachment converts said connector core into a first class of connector, wherein said second envelope attachment converts said connector core into a second class of connector, and wherein said second class of connector is different from said first class of connector.

14. The combination according to claim 11, wherein said connector core includes a ferrule holding one or more optical fibers.

15. A combination comprising:
a clasp for attachment to a connector core;
a first lanyard having a first end and an opposite, second end, wherein said first end of said first lanyard is attached to said clasp; and
a first fitting attached to said second end of said first lanyard, wherein said first fitting is structurally dimensioned to removably hold a first envelope attachment, where the first envelope attachment is structurally compatible to attach to said connector core, and where said first fitting is not structurally compatible to attach to said connector core.

16. The combination according to claim 15, wherein said first fitting includes an outer sleeve.

17. The combination according to claim 16, wherein an inner diameter of said outer sleeve is less than 10 mm.

18. The combination according to claim 16, wherein said first fitting further includes an inner plug, with a gap formed between said outer sleeve and said inner plug, wherein said outer sleeve and said inner plug are formed of a resilient plastic material, and wherein said outer sleeve or said inner plug or both are deformed when a circular portion of the first envelope attachment is inserted into said gap, such that a frictional force retains the first envelope attachment within the gap and removably holds the first envelope attachment to said first fitting.

19. The combination according to claim 16, wherein an inner surface of said outer sleeve include a plurality of projections and pathways, which can interact with pathways and projections formed on an outer surface of a circular portion of the first envelope attachment, and wherein insertion and partial rotation of the first envelope attachment into the outer sleeve results in a bayonet-type retention, so that said first fitting holds the first envelope attachment.

20. The combination according to claim 15, further comprising:
a second lanyard having a first end and an opposite, second end, wherein said first end of said second lanyard is attached said clasp; and
a second fitting attached to said second end of said second lanyard, wherein said second fitting is not structurally compatible to attach to said connector core.
